(19) United States
(12) Patent Application Publication
(10) Pub. No.: US 2026/0126543 A1
(43) Pub. Date: May 7, 2026

(54) DETECTION OF GROUND SURFACE HEIGHT VARIATION IN THE VICINITY OF A VEHICLE

(71) Applicant: VOLVO TRUCK CORPORATION, Göteborg (SE)

(72) Inventors: Murat KUMRU, Göteborg (SE); Mats RYDSTRÖM, Billdal (SE); Ghazaleh PANAHANDEH, Göteborg (SE); Mats JONASSON, Partille (SE); Dhurai ISAAC PRABHAHAR, Göteborg (SE)

(73) Assignee: VOLVO TRUCK CORPORATION, Göteborg (SE)

(21) Appl. No.: 19/377,309

(22) Filed: Nov. 3, 2025

(30) Foreign Application Priority Data
Nov. 4, 2024 (EP) 24210498.2

(51) Int. Cl. G01S 13/72; G01S 13/931

(52) U.S. Cl. CPC G01S 13/72; G01S 13/931; G01S 2013/9315; G01S 2013/9317; G01S 2013/93271; G01S 2013/93272

(57) ABSTRACT

A computer-implemented method for detection of ground surface height variation in a vicinity of a vehicle is disclosed. The method includes acquiring measured backscatter from a radar transceiver mounted on the vehicle and directed at the ground surface, comparing the measured backscatter to expected ground surface backscatter according to a current vehicle motion, and detecting a ground surface height variation responsive to a difference between the expected ground surface backscatter and the measured backscatter satisfying a detection criterion. The difference may indicate one or more of: a distance from the radar transceiver to the ground surface height variation, and an angular orientation relative the radar transceiver of the ground surface height variation.

### TECHNICAL FIELD

The disclosure relates generally to sensing of vehicle surroundings. In particular aspects, the disclosure relates to detection of ground surface height variation in the vicinity of a vehicle. The disclosure can be applied to heavy-duty vehicles, such as trucks, buses, mining equipment, and construction equipment, among other vehicle types. The disclosure can be useful for vehicles of any autonomy level (e.g., fully autonomous vehicles as well as vehicles controlled by a human operator). Although the disclosure may be described with respect to a particular vehicle, the disclosure is not restricted to any particular vehicle.

### BACKGROUND

In the context of vehicle control, it is generally beneficial to have information about the vehicle surroundings. One example of such information relates to ground surface height variations in the vicinity of the vehicle (e.g., edges or drop-offs in the ground surface). For example, it may be beneficial to know if there are ground surface height variations or not, and—if there are ground surface height variations—their location and orientation in relation to the vehicle.

Such information may, typically, be acquired by visual inspection and/or by use of cameras mounted on the vehicle. However, there are situations when sufficient information is unavailable (or cumbersome to acquire) through such known techniques. For example, visual inspection may require an operator to step out of the vehicle to inspect parts of the ground surface which are not visible from the operator seat (a.k.a., blind spots), and camera view may be obstructed in some situations (e.g., by dust, mud, snow, rain, fog, lack of light, etc.). Furthermore, it may be challenging (e.g., for a vehicle operator or an autonomous driving system) to interpret visual images to extract spatial information such as ground surface height variations.

Thus, there is a need for alternative approaches for detection of ground surface height variation in the vicinity of a vehicle.

### SUMMARY

According to a first aspect of the disclosure, a computer system for detection of ground surface height variation in a vicinity of a vehicle is provided. The computer system comprises processing circuitry configured to acquire measured backscatter from a radar transceiver mounted on the vehicle and directed at the ground surface, compare the measured backscatter to expected ground surface backscatter according to a current vehicle motion, and detect a ground surface height variation responsive to a difference between the expected ground surface backscatter and the measured backscatter satisfying a detection criterion. The first aspect of the disclosure may seek to provide or improve approaches for detection of ground surface height variation in the vicinity of a vehicle. A technical benefit may include enhanced vehicle control and/or increased vehicle safety.

According to a second aspect of the disclosure, a vehicle is provided, which comprises the computer system of the first aspect. The second aspect of the disclosure may seek to provide a vehicle configured for (improved) detection of ground surface height variation in the vicinity of the vehicle. A technical benefit may include enhanced vehicle control and/or increased vehicle safety.

Optionally in some examples, including in at least one preferred example, the vehicle may further comprise one or more radar transceivers mounted on the vehicle and directed at the ground surface, and configured to provide the measured backscatter.

According to a third aspect of the disclosure, a computer-implemented method for detection of ground surface height variation in a vicinity of a vehicle is provided. The method comprises acquiring (by processing circuitry of a computer system) measured backscatter from a radar transceiver mounted on the vehicle and directed at the ground surface, comparing (by the processing circuitry) the measured backscatter to expected ground surface backscatter according to a current vehicle motion, and detecting (by the processing circuitry) a ground surface height variation responsive to a difference between the expected ground surface backscatter and the measured backscatter satisfying a detection criterion. The third aspect of the disclosure may seek to provide or improve approaches for detection of ground surface height variation in the vicinity of a vehicle. A technical benefit may include enhanced vehicle control and/or increased vehicle safety.

Optionally in some examples, including in at least one preferred example, the detected ground surface height variation may comprise an edge of the ground surface. A technical benefit may include that an edge of the ground surface may be avoided, which typically reduces accidents and vehicle damage/wear.

Optionally in some examples, including in at least one preferred example, the method may further comprise determining (by the processing circuitry) the expected ground surface backscatter according to the current vehicle motion. A technical benefit may include that the backscatter processing is conveniently handled by the same processing circuitry, which may reduce signaling and/or latency.

Optionally in some examples, including in at least one preferred example, the current vehicle motion may comprise vehicle velocity over the ground surface in a direction corresponding to a facing direction or boresight direction of the radar transceiver. A technical benefit may include that the backscatter measurements may be used to estimate/determine the current vehicle motion.

Optionally in some examples, including in at least one preferred example, the measured backscatter may comprise signal power distribution in a space spanned by radial velocity of the radar transceiver relative to the ground surface and by radial distance of the radar transceiver from the ground surface. A technical benefit may include that the measured backscatter is directly represented by parameters readily available from the radar transceiver, which may reduce processing.

Optionally in some examples, including in at least one preferred example, the expected ground surface backscatter may indicate an expected shape in the space spanned by radial velocity of the radar transceiver relative to the ground surface and by radial distance of the radar transceiver from the ground surface. A technical benefit may include that the expected ground surface backscatter is conveniently recognizable.

Optionally in some examples, including in at least one preferred example, comparing the measured backscatter to the expected ground surface backscatter may comprise applying (by the processing circuitry) a spatial filter to the measured backscatter, wherein the spatial filter corresponds to the expected shape in the space spanned by radial velocity of the radar transceiver relative to the ground surface and by radial distance of the radar transceiver from the ground surface. A technical benefit may include simplicity of implementation of the comparison.

Optionally in some examples, including in at least one preferred example, the detection criterion may comprise that a signal power profile of the measured backscatter as filtered has a more prominent power decrease with radial distance than a corresponding signal power profile of the expected ground surface backscatter. A technical benefit may include simplicity of implementation of the detection.

Optionally in some examples, including in at least one preferred example, the difference between the expected ground surface backscatter and the measured backscatter may indicate one or more of: a distance from the radar transceiver to the ground surface height variation, and an angular orientation relative the radar transceiver of the ground surface height variation. A technical benefit may include that useful information regarding the ground surface height variation is provided.

Optionally in some examples, including in at least one preferred example, the method may further comprise causing (by the processing circuitry) a safety enhancing action responsive to detection of the ground surface height variation. A technical benefit may include that ground surface height variation may be adequately handled in the vehicle control process, which may enable reduction of accidents and vehicle damage/wear while not unnecessarily limiting the vehicle operation.

According to a fourth aspect of the disclosure, a computer program product is provided, which comprises program code for performing, when executed by the processing circuitry, the method of the third aspect.

According to a fifth aspect of the disclosure, a non-transitory computer-readable storage medium comprising instructions is provided, which when executed by the processing circuitry, cause the processing circuitry to perform the method of the third aspect.

The fourth and/or fifth aspect of the disclosure may seek to convey program code for enabling or improving detection of ground surface height variation in the vicinity of a vehicle. A technical benefit may include that new vehicles and/or legacy vehicles may be conveniently configured, by software installation/update, to acquire measured backscatter from a radar transceiver mounted on the vehicle and directed at the ground surface, compare the measured backscatter to expected ground surface backscatter according to a current vehicle motion, and detect a ground surface height variation responsive to a difference between the expected ground surface backscatter and the measured backscatter satisfying a detection criterion.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 is a flowchart illustrating a method according to some examples.

FIG. 2 is a schematic drawing illustrating a vehicle according to some examples.

FIG. 3 is a collection of schematic drawings illustrating vehicles and some radar system parameters according to some examples.

FIG. 4 is a plot illustrating a power distribution according to some examples.

FIG. 5 is a plot illustrating relationships between radial velocity and radial distance according to some examples.

FIG. 6 is a collection of plots illustrating backscatter in absence and presence of a ground surface height variation according to some examples.

FIG. 7 is a collection of schematic drawings illustrating respective vehicles and a corresponding ground surface height variation according to some examples.

FIG. 8 is a collection of plots illustrating backscatter in absence and presence of a ground surface height variation according to some examples.

FIG. 9 is a schematic diagram illustrating a computer system for implementing examples disclosed herein according to some examples.

FIG. 10 is a schematic drawing illustrating a computer program product in the form of a non-transitory computer-readable storage medium according to some examples.

FIG. 11 is a schematic block diagram of a control unit according to some examples.

### DETAILED DESCRIPTION

The detailed description set forth below provides information and examples of the disclosed technology with sufficient detail to enable those skilled in the art to practice the disclosure.

As already mentioned, there is a need for alternative approaches for detection of ground surface height variation in the vicinity of a vehicle. This is addressed by the current disclosure.

According to some examples, the approaches described herein may improve existing detection of ground surface height variation in the vicinity of a vehicle. For example, additional information regarding ground surface height variation may be provided by the approaches described herein. Alternatively or additionally, the operator may not be required to step out of the vehicle to obtain information regarding ground surface height variation when the approaches described herein are applied. Yet alternatively or additionally, when the approaches described herein are applied, information regarding ground surface height variation may be provided even if a camera view is obstructed. Yet alternatively or additionally, information regarding ground surface height variation as provided by the approaches described herein may be less challenging to interpret in terms of spatial information than some visual images. According to some examples, the information regarding ground surface height variation as provided by the approaches described herein may be combined with information obtained through visual inspection (e.g., to improve extraction of spatial information and/or to highlight ground surface height variation in a visual image rendered via a user interface).

Generally, the term “ground surface height variation” is meant to encompass any height variation of the ground surface, as suitable (e.g., an edge, or a gradual decline/incline). A ground surface height variation may, for example, refer to a deviation from a (substantially) horizontal plane. Alternatively or additionally, a ground surface height variation may refer to a deviation from a plane on which the wheels of the vehicle rests. In some examples, a ground surface height variation is defined as a deviation from a suitable plane, wherein the deviation exceeds a height variation threshold. Typical examples of interesting ground surface height variations include (but are not limited to) cliff edges and other drop-offs, pot-holes, speed bumps, sidewalk edges, edges of refuges and other road partitions, etc.

Also generally, the term “vicinity” may be interpreted in any suitable way. For example, the vicinity of a vehicle may refer to anything within a specified distance from the vehicle. The distance may be static or dynamic (e.g., increasing with increasing vehicle speed). Alternatively or additionally, the vicinity of a vehicle may refer to locations from which a radar transceiver mounted on the vehicle can receive backscatter when there is a surface present at the location.

A radar transceiver generally comprises a radar signal generator, at least one transmit antenna, at least one receive antenna, and a radar backscatter detector. The radar transceiver transmits a radar signal generated by the radar signal generator via the at least one transmit antenna. The transmitted signal interacts with the environment and is partly reflected back towards the at least one receive antenna. This part of the radar signal is referred to herein as radar signal backscatter, or just backscatter. The backscatter is detected by the radar backscatter detector. Radar transceivers, and their operation, are generally known and will therefore not be discussed in more detail herein.

WO2023169652A1 describes a ground radar system comprising radar transceivers applicable for the techniques described herein.

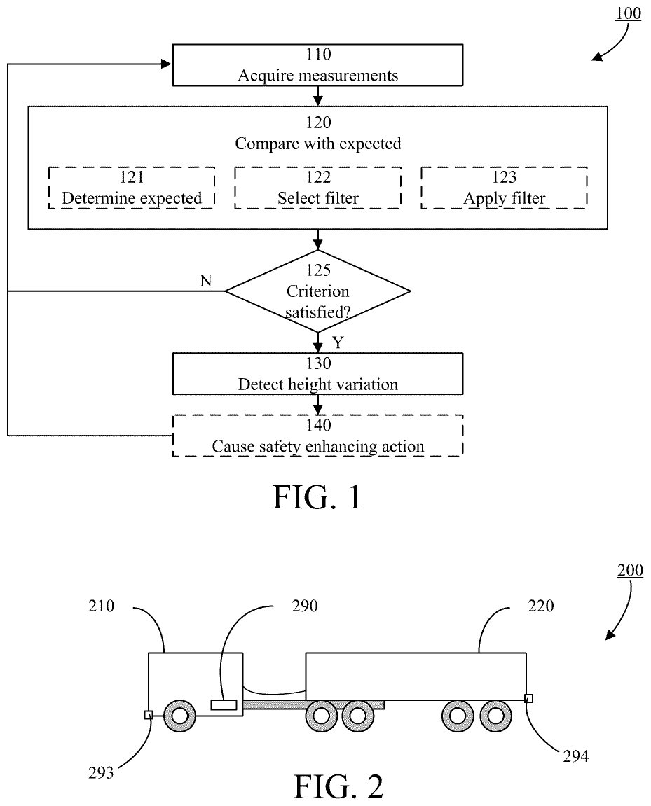

FIG. 1 illustrates an example computer-implemented method 100 for detection of ground surface height variation in the vicinity of a vehicle.

As illustrated by 110, measured backscatter is acquired from a radar transceiver which is mounted on the vehicle and directed at the ground surface.

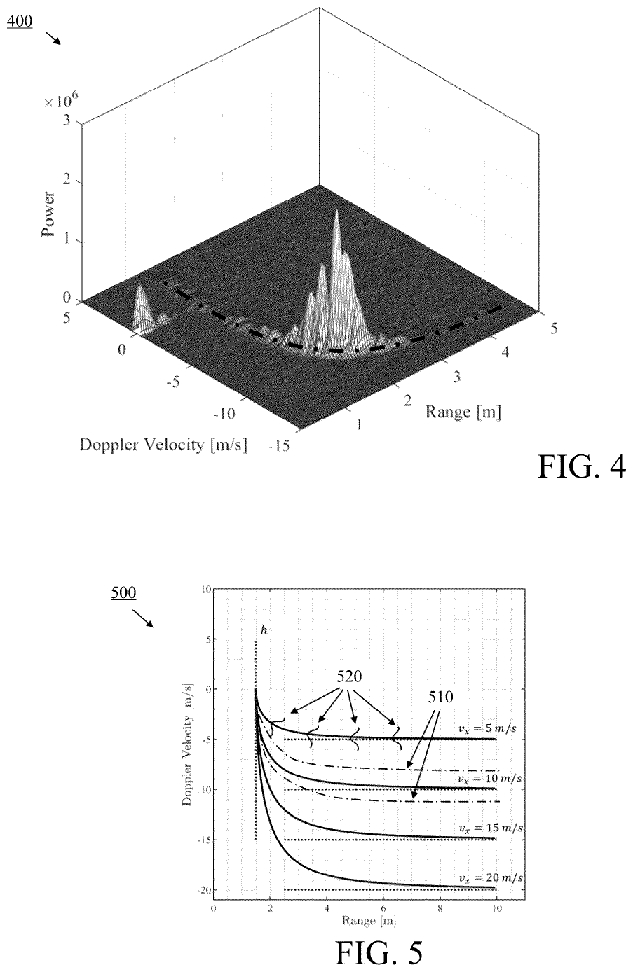

It is appreciated that the measured backscatter can be acquired in several different ways. According to some examples, the backscatter is acquired as raw signal data such as complex-valued samples of in-phase (I) and quadrature (Q) components of the reflected radar signal from an analog-to-digital converter (ADC). According to some examples, the backscatter is acquired as range and/or velocity data indicative of the range and/or the velocity to objects in the environment that are reflecting the transmitted radar signal. A range-Doppler map is a representation comprising received signal power for different ranges and different relative radial velocities. According to some examples, the backscatter is acquired as range-Doppler maps. Example range-Doppler maps are illustrated in FIGS. 4-6 and will be discussed in more detail below. A range-Doppler map may also be referred to as a space spanned by radial velocity of the radar transceiver relative to the ground surface and by radial distance of the radar transceiver from the ground surface.

Thus, generally, the measured backscatter can comprise the actual signal received by the radar transceiver (e.g., represented by raw I/Q signal data), and/or the measured backscatter can comprise some more sophisticated representation of the environment that causes the backscatter to occur by reflection (e.g., a range-Doppler map) which is derived from the actual signal received by the radar transceiver.

The measured backscatter is compared to expected ground surface backscatter, as illustrated by 120. As illustrated by 121, the method 100 may (optionally) comprise determining the expected ground surface backscatter according to the current vehicle motion (as part of, or prior to, the comparison 120).

The expected ground surface backscatter is backscatter as expected according to a current vehicle motion; typically assuming a planar ground surface. Expected ground surface backscatter typically refers herein to characteristics such as delay, amplitude, and frequency shift of the part of the transmitted radar signal that is reflected by the environment and received at the radar transceiver, as discussed above. For example, the current vehicle motion may comprise vehicle velocity over the ground surface in a direction corresponding to a facing direction or boresight direction of the radar transceiver. Thus, for front-facing and back-facing radar transceivers, the current vehicle motion may be a current longitudinal speed of the vehicle.

Information regarding the current vehicle motion may be acquired in any suitable way (e.g., as known in the art). For example, the current vehicle motion may be estimated based on any suitable combination of wheel speed sensor data, steering angle information, positioning data (e.g., global navigation system data), etc. Alternatively or additionally, information regarding the current vehicle motion may be implicitly or explicitly available from the acquired backscatter itself (e.g., as explained in WO2023169652A1).

Comparing 120 the measured backscatter to the expected ground surface backscatter may (optionally) comprise applying a suitable filter to the measured backscatter, as illustrated by 123, wherein the filter represents one or more characteristics of the expected backscatter. In some examples, comparing 120 the measured backscatter to the expected ground surface backscatter may (optionally) also comprise selecting a filter from a plurality of available filters, as illustrated by 122, based on the current vehicle motion. For example, for each of a collection of vehicle velocities in a facing direction or boresight direction of the radar transceiver, the plurality of available filters may comprise a suitable filter. Alternatively or additionally, the filter may be constructed (i.e., derived) on demand, using one or more mathematical models or functions such as polynomial functions, piecewise linear approximations, and the like.

After 120, it is checked whether or not a difference between the expected ground surface backscatter and the measured backscatter satisfies a detection criterion, as illustrated by 125. If the detection criterion is satisfied (Y-path out of 125), the method continues to 130. If the detection criterion is not satisfied (N-path out of 125), the method returns to 110, where new measurements are acquired.

As illustrated by 130, a ground surface height variation is detected responsive to the difference between the expected ground surface backscatter and the measured backscatter satisfying the detection criterion.

Put differently, the system transmits radar signal towards the ground surface and monitors the resulting backscatter from the ground surface. The system, having regard to (e.g., the nominal height of the radar transceiver over the ground surface and the current velocity of the vehicle over the surface) expects a certain type of radar backscatter. The detection criterion is fulfilled if the expected ground surface backscatter differs enough from the measured backscatter; then it is likely that the ground surface has a height variation which has caused the discrepancy.

As illustrated by 140, the method 100 may (optionally) comprise causing (e.g., performing) a safety enhancing action responsive to detection of the ground surface height variation. The safety enhancing action may be any one or more suitable action.

For example, causing a safety enhancing action may comprise issuing a warning for an operator of the vehicle. The warning may take any suitable form (e.g., visual, audial, tactile, etc.). In some examples, the warning may be issued by rendering a representation of the detected ground surface height variation via a user interface (e.g., overlaid on a camera image).

Alternatively or additionally, causing a safety enhancing action may comprise applying velocity constraints (e.g., halting the vehicle, slowing down the vehicle, hindering the vehicle from exceeding a velocity limit, etc.).

Yet alternatively or additionally, causing a safety enhancing action may comprise issuing an alert for an autonomous drive function of the vehicle.

Yet alternatively or additionally, causing a safety enhancing action may comprise sending a report to a remote vehicle service function. For example, the report may comprise information regarding the detected ground surface height variation (e.g., location, orientation, shape, height difference, etc.). Such information may be used by the remote vehicle service function, for example, to create/update a ground surface height variation database which can be used to inform/control vehicles in the relevant location going forward.

Finally, the method may return to 110, where new measurements are acquired. It should be noted that, in some examples, new measurements are acquired in and compared to expected backscatter in parallel to execution of 125, 130, 140.

In some examples, the measured backscatter (and the expected backscatter) comprises a signal power distribution in a space spanned by radial velocity of the radar transceiver relative to the ground surface and by radial distance of the radar transceiver from the ground surface. The radial velocity may be expressed in terms of Doppler shift between a transmitted radar signal and the correspondingly received radar signal (as reflected by the ground surface). The radial distance may be implied by the delay between transmission of a radar signal and reception of the correspondingly reflected radar signal.

Typically, the expected ground surface backscatter indicates an expected shape in the space spanned by radial velocity of the radar transceiver relative to the ground surface and by radial distance of the radar transceiver from the ground surface. To this end, the applicable (e.g., selected) filter of 122 and 123 may be a spatial filter that corresponds to the expected shape. For example, applying 123 the spatial filter to the measured backscatter may comprise applying a mask to the measured backscatter, where the mask passes signal power at radial velocity-distance coordinate points belonging to the expected shape, and blocks any other signal power. Alternatively or additionally, a weighting filter may be applied, which emphasizes signal power near the expected radial velocity (distance coordinate points belonging to the expected shape).

When the backscatter comprises signal power distribution as a function of radial distance (e.g., signal power distribution in a space spanned by radial velocity and distance), the detection criterion may comprise that the signal power profile of the measured backscatter as filtered (based on the expected backscatter) has a more prominent power decrease (when the height variation is a height decrease, such as an edge or drop-off) with radial distance than the corresponding signal power profile of the expected ground surface backscatter (i.e., a difference between the expected ground surface backscatter and the measured backscatter).

The prominence of the power decrease may be expressed in any suitable way. For example, there may be a step-like decrease in power for the measured backscatter which has no counterpart in the expected backscatter. Thus, that the signal power profile of the measured backscatter as filtered has a more prominent power decrease with radial distance than the corresponding signal power profile of the expected ground surface backscatter is meant to include the case where the signal power profile of the measured backscatter as filtered has zero (or very close to zero) power for radial distances longer than a cut-off distance. Put differently, the term “power decrease” is meant to include abrupt cessation (a cut-off) of power at a cut-off distance (i.e., that the signal disappears for radial distances above the cut-off power). Alternatively or additionally, there may be a gradual decrease in power for the measured backscatter which has a steeper slope than any counterpart in the expected backscatter. Yet alternatively or additionally, there may be a decrease in power for the measured backscatter which is relatively larger than any counterpart in the expected backscatter.

Generally, the signal power profile of the measured backscatter as filtered having a more prominent power decrease with radial distance than the corresponding signal power profile of the expected ground surface backscatter may include any one or more suitable situation(s) where the backscatter power becomes weaker (abruptly or gradually) with increasing radial distance.

According to some examples, the measured backscatter may have zero signal power for radial distances that are longer than some cut-off distance, while the expected backscatter has non-zero signal power for radial distances that are shorter than the cut-off distance. According to some examples, a signal power ratio between the measured backscatter and the expected backscatter may have a lower value for radial distances that are longer than some cut-off distance, than for radial distances that are shorter than the cut-off distance. According to some examples with signal power ratio between the measured backscatter and the expected backscatter, a difference between the signal power ratio for radial distances that are shorter than some cut-off distance and the signal power ratio for radial distances that are longer than the cut-off distance exceeds a threshold value, or fulfills another suitable criterion.

Thus, when the backscatter comprises signal power distribution in a space spanned by radial velocity and distance, the expected backscatter may be determined 121 and/or a suitable filter may be selected 122 by identifying an expected shape in the space spanned by radial velocity of the radar transceiver relative to the ground surface and by radial distance of the radar transceiver from the ground surface (e.g., by matching the measured backscatter for relatively short radial distances to one of several known shapes for planar ground surface corresponding to different vehicle velocities). Comparing 120 the measured backscatter to the expected backscatter may comprise applying 123 a spatial filter that corresponds to the expected shape, and the detection criterion 125 may comprise that the signal power profile of the measured backscatter as filtered has a prominent power decrease with radial distance (e.g., a cut-off) which has no correspondence in the expected backscatter.

Generally, the detection may include determination of location and/or orientation and/or shape of the ground surface height variation. For example, the difference between the expected ground surface backscatter and the measured backscatter may indicate a distance from the radar transceiver to the ground surface height variation and/or an angular orientation relative the radar transceiver of the ground surface height variation, from which location and/or orientation and/or shape of the ground surface height variation can be derived (e.g., in relation to the vehicle).

When the backscatter comprises signal power distribution in a space spanned by radial velocity and distance, the radial distance where the measured backscatter declines more prominently than the expected backscatter indicates the distance from the radar transceiver to the ground surface height variation. An inclination in the velocity-distance plane of a line representing the decline indicates an angular orientation relative the radar transceiver of the ground surface height variation.

FIG. 2 schematically illustrates an example vehicle 200 for cargo transport where the techniques disclosed herein can be advantageously applied. The vehicle 200 comprises a truck/tractor/towing unit 210 configured to tow one or more trailer unit(s) 220 in a known manner. The tractor unit 210 and/or the trailer unit(s) 220 may comprise a vehicle control unit (VCU) 290 configured to perform various vehicle control functions, such as vehicle motion management (VMM), etc. Any of one or more VCU(s) 290 may be configured to perform, or cause performance of, the techniques disclosed herein. For example, the VCU 290 may be configured to perform the method 100 of FIG. 1.

Mounted on the vehicle 200, there are radar transceivers 293, 294 directed at the ground surface and configured to provide measured backscatter. For example, there may be at least one forward-facing radar transceiver 293 and/or at least one backward-facing radar transceiver 294. In some examples, there may—additionally or alternatively—be radar transceiver(s) facing other directions than forward/backward, which may enable ground surface height variation detection also in such directions. In some examples, there may be two or more radar transceivers facing (substantially) the same direction, which typically enhances the ground surface height variation detection in that direction.

Thus, the vehicle 200 is equipped with a radar sensor system comprising one or more radar transceivers 293, 294 arranged to transmit respective radar signals and to receive radar signal backscatter from the environment in vicinity of the radar transceiver, in particular from the surface supporting the vehicle.

The radar sensor system transceivers 293, 294 are directed at the ground surface and can therefore be used to determine a speed over ground of the vehicle in a reliable manner. A ground speed radar module 293, 294 can be configured to determine a one dimensional velocity of the vehicle, such as the longitudinal velocity vₓ of the vehicle over the ground surface, a two-dimensional velocity vector [vₓ, v_{y}] or a three-dimensional velocity vector [vₓ, v_{y}, v_{z}] of a vehicle with respect to a surface supporting the vehicle, where the orientation of the x, y and z axes used in the present disclosure represent longitudinal, lateral, and vertical coordinates in a vehicle centric system. The radar system on the vehicle can, generally, be used to determine one or more motion parameters of the vehicle such as vehicle unit speed (vₓ, v_{y}, v_{z}), vehicle unit acceleration (aₓ, a_{y}, a_{z}), vehicle unit pitch angle (φ_{y}), vehicle unit roll angle (φₓ), vehicle unit pitch motion (ω_{y}), vehicle unit roll motion (ωₓ), and vehicle unit yaw motion (ω_{z}). The radar system on the vehicle can also be used to determine vehicle unit heave, i.e., the vehicle unit height along the z-axis over the ground surface.

Many of the methods and functions discussed herein rely on data obtained from the one or more radar transceivers 293, 294. The VCU 290 or VCUs may be communicatively coupled to processing circuitry integrated with the radar transceivers 293, 294. Some VCUs discussed herein may also comprise hardware for generating, transmitting and/or receiving radar signals. This disclosure is not limited to any particular VCU hardware architecture, nor any particular radar transceiver architecture.

The principle of determining motion parameters of the vehicle 200 using the radar transceivers 293, 294 builds on the disclosure of, e.g., US 2004/0138802 and other known ground speed radar systems, such as the systems disclosed in WO2023169746 A1. Methods of varying complexity can be applied to determine vehicle motion parameters by analyzing radar backscatter from the surface supporting the vehicle. Such methods are known and will not be discussed in detail herein.

Some example approaches for robust radar-based vehicle motion estimation will now be explained, along with their application to detection of ground surface height variations.

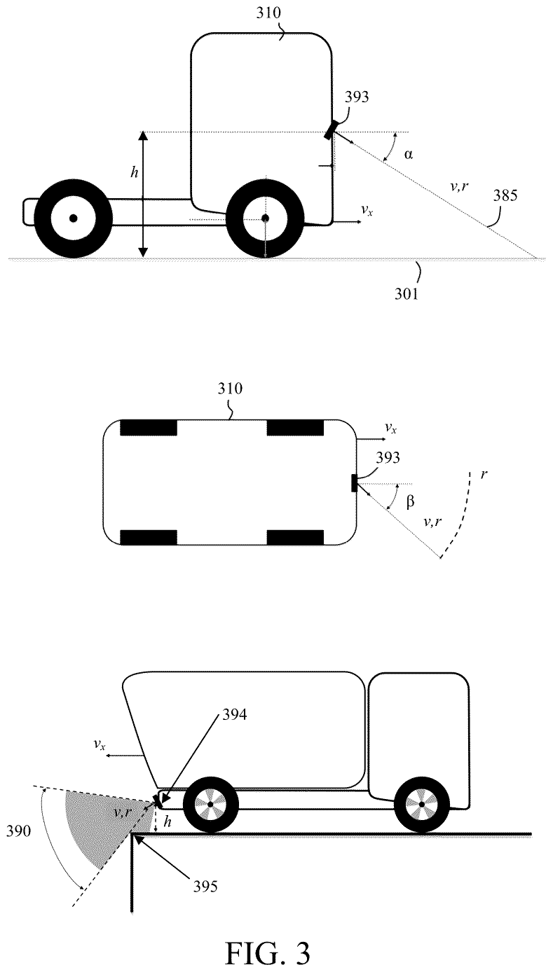

FIG. 3 schematically illustrates vehicles and some radar system parameters according to some examples.

With reference to the somewhat simplified example in the uppermost drawing of FIG. 3, suppose that the truck 310 moves in its longitudinal direction along the x-axis, and let vₓ denote the longitudinal velocity with respect to the surface 301 along this axis. Let h define the position of the radar sensor 393 with respect to the ground. The ground 301 moves at a radial velocity v relative to the radar transceiver 393. Radial velocity will often be referred to herein as the Doppler velocity, and the two terms can be used interchangeably.

The distance from the radar transceiver 393 to a point in the area on the surface illuminated by the radar transceiver is r. The radial velocity v and the range (radial distance) r, along an observation direction 385 with an elevation angle α can be expressed as

$$v = - cos ( α ) {v}_{x} \qquad ( 1 )$$

$$r = \frac{1}{sin ( α )} ( h ) \qquad ( 2 )$$

The observation direction may, e.g., be the boresight direction of the radar transceiver, i.e., the direction of maximum antenna gain in a single main lobe radar transceiver, or some other direction. It is noted that both of these observations are functions of the elevation angle α, which can be regarded as an implicit variable.

The middle drawing of FIG. 3 shows a top view of an example vehicle unit 310 with a radar transceiver 393. In this case the radar beam is also angled laterally at an azimuth angle β in addition to the elevation angle α, while the range to the illuminated surface area is kept the same as indicated by the dashed line. For an observation direction with an elevation angle α and an azimuth angle β, the range and radial velocities are given as

$$v = - cos ( α ) cos ( β ) {v}_{x} \qquad ( 3 )$$

$$r = \frac{1}{sin ( α )} ( h ) \qquad ( 4 )$$

With reference to the somewhat simplified example in the lowermost drawing of FIG. 3, suppose that the truck reverses in its longitudinal direction along the x-axis, and let vₓ denote the (negative) longitudinal velocity with respect to the ground surface along this axis. Let h define the shortest distance between the radar sensor 394 and the ground surface. The principles for this backward-facing example are the same as explained for the forward-facing example. Thereby, an edge 395 in the ground surface may be detected since the backscatter for the angular interval 390 has substantially lower power (if any) than if the ground surface would be planar (i.e., would not have the edge 395).

The radar transceiver 293, 294, 393, 394 generally illuminates an area on the road surface and not a localized small point, since the radar beam is normally not a true laser-like or pencil-shaped beam. Thus, even single-beam radar transceivers simultaneously collect radar backscatter from different observation directions due to the spread of the main radar transmission lobe, i.e., due to the shape of the main lobe of the radar transceiver antenna including effects of, e.g., the radar front end on the overall transmission pattern of the radar transceiver. The extent of the spread depends mainly on the antenna characteristics of the radar transceiver but also the reflection properties of the environment and the vehicle components in the near-field of the radar transceiver. This means that there will be a spread in elevation angles in the transmitted radar signal, and also in the received radar backscatter, where an area of the road surface has been illuminated with varying degree of intensity, from some range r₁ at corresponding elevation angle α₁ to a range r₂ at elevation angle α₂. The largest received radar backscatter power is most likely received from the boresight direction, at least on average. The average received signal power then declines with elevation angle from the elevation angle of the radar transceiver boresight direction in a known manner.

By letting α and/or β vary over some predetermined span, such as between a small angle corresponding to a maximum range and an angle close to perpendicular to the ground surface, Doppler v is obtained as function of range r, since each α and/or β gives a tuple (v, r). The equations (1-4) can thus be used to determine an expected range-Doppler appearance of received radar backscatter from the ground surface, given an expected or predicted vehicle motion and a radar transceiver geometry.

In essence, this means that a range-Doppler map of the received radar backscatter, i.e., a data set indicating the different ranges and radial velocities at which radar backscatter energy has been detected by the radar transceiver 293, 294, 393, 394, will exhibit a curved banana-like shape.

An example range-Doppler power spectrum 400 from a real-world radar transceiver is illustrated in FIG. 4 (signal power distribution in a space spanned by radial velocity and radial distance), where the expected range-Doppler appearance is indicated by a dash-dotted line. Here the impact from the antenna diagram can be seen as a variation in received radar backscatter power. The antenna boresight direction is in this case somewhere close to the peak of the power of the received backscatter. The artefact at zero range and zero Doppler is most likely due to near-field effects, i.e., objects close to the antenna. This power spectrum is likely to vary over time since it is impacted by the radar reflection properties of the surface and also at least to some extent by the radar transceiver front end.

In the example range-Doppler map 500 in FIG. 5, some expected range-Doppler appearances of received radar backscatter has been plotted for different vehicle longitudinal velocities vₓ. Thus, FIG. 5 illustrates some expected shapes as relationships between radial velocity and radial distance, where the current vehicle motion is represented by the velocity vₓ over the ground surface in a direction corresponding to a facing direction or boresight direction of the radar transceiver. The radar is not able to observe the ground for the elevation angles

$$α > \frac{π}{2}$$

as the vehicle body obstructs the field of view. Note that the banana-like curves all start at a range corresponding to the height of the radar transceiver over ground which corresponds to a direction more or less perpendicular to the ground, where radial (Doppler) velocity is close to zero as expected. The curves all converge to the longitudinal velocity of the vehicle, which happens as the azimuth angle (and thus also the distance r) becomes large, at least when α and β are small.

To summarize, the characteristic behavior of ground surface radar backscatter as function of radar system geometry and vehicle motion can be leveraged in order to provide improved vehicle motion estimation, i.e., to improve the determination of one or more motion parameters on a vehicle, and also to determine or refine data related to radar system geometry on a vehicle, such as the height over ground of the radar transceiver, or its boresight angle relative to the surface supporting the vehicle. Having some idea of the current motion of a vehicle, such as its approximate longitudinal velocity, and the geometry of the radar system arranged on the vehicle, an expected range-Doppler appearance of the received backscatter from a given radar transceiver can be determined. This expected range-Doppler appearance can then be used to define a filter 510, 520 that can be applied to the received backscatter from the radar transceiver. Such filters may also be used as spatial filters for application to the measured backscatter, wherein the spatial filter corresponds to an expected shape.

The expected range-Doppler appearance can be determined analytically, e.g., by varying α and β in equation (3) and (4) above to get pairs of range and radial velocities which constitute the expected range-Doppler appearance. There are, however, also other ways to determine the expected range-Doppler appearance given a certain vehicle motion over the surface supporting the vehicle. One such method is an experimental method where the vehicle is moved over the surface at a known motion state (known velocity, etc.) and the range-Doppler appearance is recorded a few times, averaged, and then stored in a database indexed by vehicle motion state. This database can then be consulted if an expected range-Doppler appearance for a given motion state is wanted.

An expected range-Doppler appearance can, according to the teachings herein, be formatted in different ways. According to one example the expected range-Doppler appearance is formatted as a curve in the range-Doppler plane, i.e., as a function v=ƒ(r). According to another example the expected range-Doppler appearance is a discrete set of magnitudes indexed by range r and by velocity v, i.e., similar to a fast Fourier transform based discrete range-Doppler map obtained from a radar transceiver. According to yet another example the expected range-Doppler appearance is a continuous three-dimensional function which indicates expected power (possibly with phase) over range r and velocity v.

The expected range-Doppler appearance can be used by the one or more VCUs on the vehicle to define one or more range-Doppler filters and signal processing functions that can be applied to the range-Doppler data obtained from the one or more radar transceivers. Suppose that the range-Doppler data set is indexed by range r and by radial velocity v, such that P_{r,d} is the received signal power in the radar backscatter corresponding to a range r and a radial velocity v. The power P_{r,d} may be just a magnitude or an amplitude with corresponding relative phase value.

FIG. 5 illustrates a first example filter 510 applied to the vₓ=10 m/s curve. This filter is a gating filter (which can be used for masking the measured backscatter) which will suppress all signal energy outside of the dash-dotted lines. This, interference from foreign objects on the road surface such as water spray, mud, snow, or obstacles on the road surface will be suppressed and thus not distort the estimation of vehicle speed over ground. The gating filter can, for instance, be defined as a region around the expected range-Doppler appearance defined by offsetting the expected range-Doppler appearance curve by a predetermined amount in the Doppler-direction.

Suppose for instance that P_{r,d} is the received signal power in the radar backscatter corresponding to a range r and a radial velocity v in some radar system. The gating function will then zero out all received radar backscatter power if the coordinate in the range-Doppler map, i.e., (v, r) lies outside of the gating region, leaving only the received radar backscatter power at coordinates in the range-Doppler map that lie inside of the gating region.

This type of gating filter can be used to pre-process that radar data obtained from the radar transceivers in, e.g., US 2004/0138802 A1 and/or in WO2023169746 A1, and also in the other ground-speed radar system known in the art.

FIG. 5 also illustrates a second example filter 520. This filter is instead a weighting filter that applies larger weights to received radar backscatter power close to the expected appearance of the road surface, i.e., close to the banana-like curve, and smaller weights to received radar backscatter further away from the expected appearance. This will again emphasize radar backscatter that has likely resulted from reflection at the road surface and suppress of radar backscatter which may otherwise distort the estimation of vehicle motion relative to the road surface. The weights can, for instance, be determined function that declines in a direction perpendicular to the expected range-Doppler appearance curve. The decline may, e.g., be according to a second-order expression, a sine function, or an exponential decline. The decline in the weight function may also be linear.

Suppose again that P_{r,d} is the received signal power in the radar backscatter corresponding to a range r and a radial velocity v in some radar system. The weighting function will then apply large magnitude weights to all received radar backscatter power at coordinates (v, r) close (in Euclidean distance or by some other distance metric) to the expected range-Doppler appearance curve, and smaller weights to received radar backscatter power at coordinates (v,r) further away from the expected range-Doppler appearance curve.

This type of weighting filter can be used to pre-process that radar data obtained from the radar transceivers in, e.g., US 2004/0138802 A1 and/or in WO2023169746 A1, and also in the other ground-speed radar system known in the art.

The expected range-Doppler appearance is, generally, a function ƒ_{G,M}(r, v) that is parameterized by the radar system geometry G and the current vehicle motion M (such as the position of the radar transceiver on the vehicle and the speed of the vehicle over the surface 101). Given a radar system geometry G and a current vehicle motion M, it is possible to plot what the radar backscatter is expected to look like in the range-Doppler domain. The expected range-Doppler appearance function ƒ_{G,M}(r, v) can be given in magnitude only, or in amplitude and phase, just like any range-Doppler map.

According to one example application, the expected range-Doppler appearance function ƒ_{G,M}(r, v) can be used to define a weighting function which emphasizes backscatter power P_{r,d} where backscatter power is expected according to the function ƒ_{G,M}(r, v), while suppressing backscatter power at other parts in the range-Doppler map. In other words, received radar backscatter power at index (r, d) from the radar transceiver can be processed as

$${P}_{r , d}^{proc} = w ( r , d ) {P}_{r , d}$$

where w(r, d) is a weight determined from the magnitude of the function ƒ_{G,M}(r, v). In case the weights are binary (either zero or one), the filter will be a gating filter which rejects radar backscatter power too far from the expected range-Doppler appearance curve. The weights w(r, d) are preferably also configured so as to account for uncertainty in the radar system geometry G and/or in the current vehicle motion M. The more accurate the information on G and M the steeper the weights can decline from the most likely expected radar backscatter curve, and vice versa. In case of large uncertainty in the radar system geometry G and/or in the current vehicle motion M a set of uniform weights may be used, which will not result in any suppression of radar backscatter power in the range-Doppler map.

The signal power distribution in a space spanned by radial velocity and radial distance (compare with FIGS. 4-5) may be used for detection of ground surface height variations, as will be exemplified in the following.

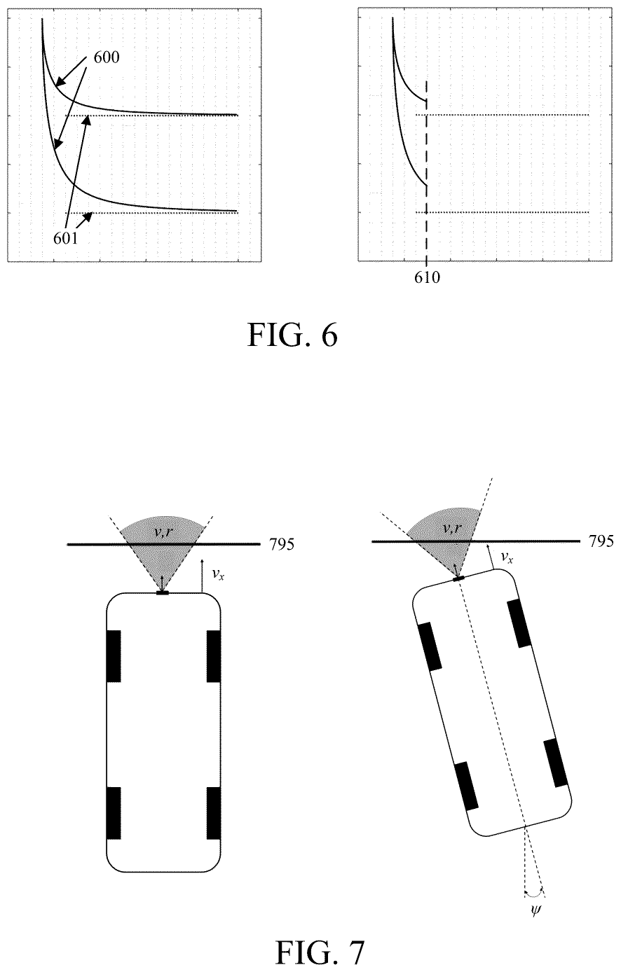

FIG. 6 schematically illustrates backscatter 600 corresponding to equations (1-2) for two different velocities (each velocity represented by one of the two lines 601) in absence of ground surface height variations (left plot) and in presence of a ground surface height variation (right plot). The cut-off 610 of the measured backscatter in the right plot (compared to the expected backscatter in the left plot) indicates that there is indeed a ground surface height variation and its distance from the radar transceiver. The cut-off 610 exemplifies that the signal power profile of the measured backscatter as filtered has a more prominent power decrease with radial distance than the corresponding signal power profile of the expected ground surface backscatter. More generally, there may be a step-like power decrease (cut-off, abrupt cessation) or a gradual decrease, as explained above.

FIG. 7 schematically illustrates a vehicle approaching an edge 795 in the ground surface at a right angle (left illustration) and at an offset angle Y (right illustration). It would be beneficial to be able to distinguish between these situations, and to be able to determine the angle Y′.

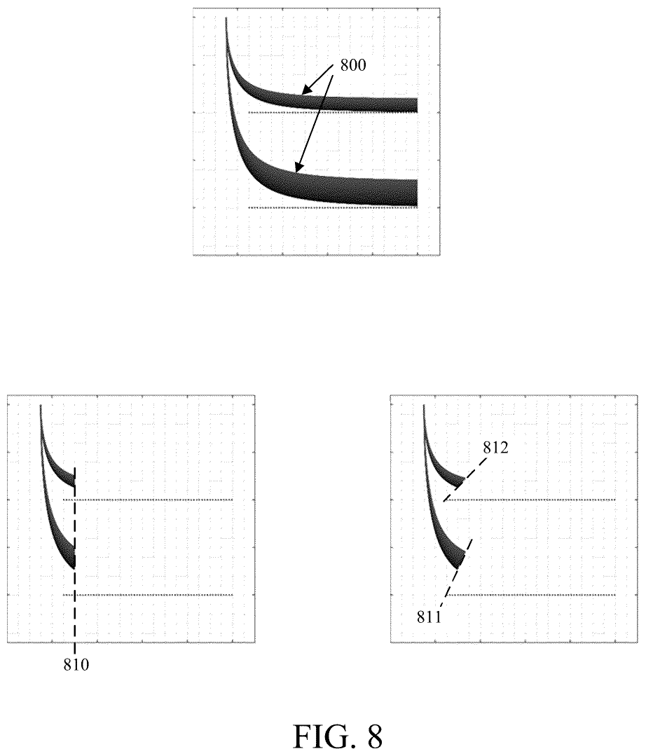

FIG. 8 schematically illustrates backscatter 800 for two different velocities (compare with 601 of FIG. 6) and corresponding to equations (3-4); i.e., using variation in both α and β. In the uppermost plot, the backscatter 800 is shown in absence of ground surface height variations. It should be noted that each of the two expected shapes has a relatively substantial width (compare with 600 of FIG. 6) which is due to the dual parametrization of both α and β.

In the lowermost left plot, the backscatter is shown in presence of ground surface height variations while approaching an edge at a right angle. As for the example in FIG. 6, the cut-off 810 of the measured backscatter indicates that there is indeed a ground surface height variation and its distance from the radar transceiver.

In the lowermost right plot, the backscatter is shown in presence of ground surface height variations while approaching an edge at an offset from the right angle. It should be noticed that the cut-offs 811, 812 are not vertical (as the cut-off 810). From the inclination of lines representing the cut-offs, an angular orientation relative the radar transceiver may be determined for the edge (e.g., by mapping the inclination to a corresponding angle for the applicable velocity).

The cut-offs 810, 811, 812 exemplify that the signal power profile of the measured backscatter as filtered has a more prominent power decrease with radial distance than the corresponding signal power profile of the expected ground surface backscatter. More generally, there may be a step-like power decrease (cut-off, abrupt cessation) when the backscatter 800 meets the lines 810, 811, 812 or a gradual decrease, as explained above. Thus, when there is a step-like power decrease in cases such as that of the lowermost right plot, the power is cut-off at different radial distances for different Doppler velocities, as represented by the non-vertical lines 811, 812.

Put differently, the signal power cut-off is manifested as a straight line in the space spanned by radial velocity of the radar transceiver relative to the ground surface and by radial distance of the radar transceiver from the ground surface, wherein the orientation of the straight line indicates an angle of the ground edge relative the direction that the radar transceiver is facing.

When the cut-off corresponds to a straight line as in FIG. 8, the edge may substantially correspond to a straight line (perpendicular or not to the facing direction or boresight direction of the radio transceiver). If the cut-off corresponds to a different shape, conclusions may be drawn regarding a corresponding shape of the ground surface height variation (e.g., a curved edge).

As already mentioned, the approaches described herein may improve existing detection of ground surface height variation in the vicinity of a vehicle. This advantage may be achieved, for example, by comparing the measured backscatter to the expected ground surface backscatter subject to the expected shape, as explained above. Using the expected shape, it is possible to improve noise suppression (e.g., removing as much noise as possible without suppressing the information carrying portions of the measured backscatter). Thus, the sensitivity to noise may be reduced and/or the collected backscatter signal energy may be increased. According to some examples, approaches described herein may be seen as a form of matched filter detection.

In some examples, the principles described and exemplified herein may be combined with one or more other height variation detection approach (e.g., camera).

For example, the result of detection by radar transceiver may be fused with the result of detection by camera (e.g., averaging, weighting, binary “OR”, etc.). The respective results may be binary (radar=edge or not, camera=edge or not), or a soft value (e.g., indicating uncertainty of the result). In the latter case, the uncertainty may be used to set weighting values (uncertain result to have less influence on the combination).

Alternatively or additionally, the result of detection by radar transceiver and the result of detection by camera may be used separately (e.g., one providing redundancy when the other is non-functional). For example, radar may be more reliable than camera if there are obstructions (e.g., dust, mud, snow) or lack of light, while camera may be more reliable than radar in rainy conditions.

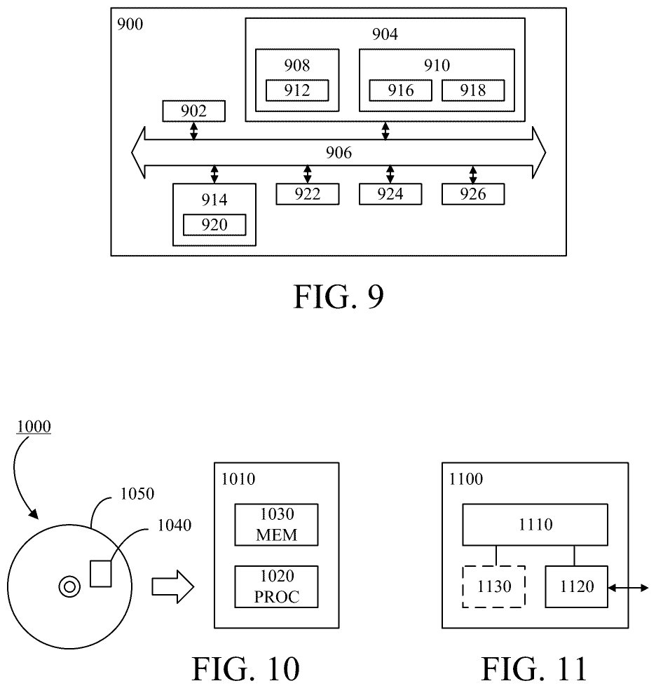

FIG. 9 is a schematic diagram of a computer system 900 for implementing examples disclosed herein. The computer system 900 is adapted to execute instructions from a computer-readable medium to perform these and/or any of the functions or processing described herein. The computer system 900 may be connected (e.g., networked) to other machines in a LAN (Local Area Network), LIN (Local Interconnect Network), automotive network communication protocol (e.g., FlexRay), an intranet, an extranet, or the Internet. While only a single device is illustrated, the computer system 900 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 900 may comprise at least one computing device or electronic device capable of including firmware, hardware, and/or executing software instructions to implement the functionality described herein. The computer system 900 may include processing circuitry 902 (e.g., processing circuitry including one or more processor devices or control units), a memory 904, and a system bus 906. The computer system 900 may include at least one computing device having the processing circuitry 902. The system bus 906 provides an interface for system components including, but not limited to, the memory 904 and the processing circuitry 902. The processing circuitry 902 may include any number of hardware components for conducting data or signal processing or for executing computer code stored in memory 904. The processing circuitry 902 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 902 may further include computer executable code that controls operation of the programmable device.

The system bus 906 may be any of several types of bus structures that may further interconnect to a memory bus (with or without a memory controller), a peripheral bus, and/or a local bus using any of a variety of bus architectures. The memory 904 may be one or more devices for storing data and/or computer code for completing or facilitating methods described herein. The memory 904 may include database components, object code components, script components, or other types of information structure for supporting the various activities herein. Any distributed or local memory device may be utilized with the systems and methods of this description. The memory 904 may be communicably connected to the processing circuitry 902 (e.g., via a circuit or any other wired, wireless, or network connection) and may include computer code for executing one or more processes described herein. The memory 904 may include non-volatile memory 908 (e.g., read-only memory (ROM), erasable programmable read-only memory (EPROM), electrically erasable programmable read-only memory (EEPROM), etc.), and volatile memory 910 (e.g., random-access memory (RAM)), or any other medium which can be used to carry or store desired program code in the form of machine-executable instructions or data structures and which can be accessed by a computer or other machine with processing circuitry 902. A basic input/output system (BIOS) 912 may be stored in the non-volatile memory 908 and can include the basic routines that help to transfer information between elements within the computer system 900.

The computer system 900 may further include or be coupled to a non-transitory computer-readable storage medium such as the storage device 914, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 914 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 914 and/or in the volatile memory 910, which may include an operating system 916 and/or one or more program modules 918. All or a portion of the examples disclosed herein may be implemented as a computer program 920 stored on a transitory or non-transitory computer-usable or computer-readable storage medium (e.g., single medium or multiple media), such as the storage device 914, which includes complex programming instructions (e.g., complex computer-readable program code) to cause the processing circuitry 902 to carry out actions described herein. Thus, the computer-readable program code of the computer program 920 can comprise software instructions for implementing the functionality of the examples described herein when executed by the processing circuitry 902. In some examples, the storage device 914 may be a computer program product (e.g., readable storage medium) storing the computer program 920 thereon, where at least a portion of a computer program 920 may be loadable (e.g., into a processor) for implementing the functionality of the examples described herein when executed by the processing circuitry 902. The processing circuitry 902 may serve as a controller or control system for the computer system 900 that is to implement the functionality described herein.

The computer system 900 may include an input device interface 922 configured to receive input and selections to be communicated to the computer system 900 when executing instructions, such as from a keyboard, mouse, touch-sensitive surface, etc. Such input devices may be connected to the processing circuitry 902 through the input device interface 922 coupled to the system bus 906 but can be connected through other interfaces, such as a parallel port, an Institute of Electrical and Electronic Engineers (IEEE) 1394 serial port, a Universal Serial Bus (USB) port, an IR interface, and the like. The computer system 900 may include an output device interface 924 configured to forward output, such as to a display, a video display unit (e.g., a liquid crystal display (LCD) or a cathode ray tube (CRT)). The computer system 900 may include a communications interface 926 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

The described examples and their equivalents may be realized in software or hardware or a combination thereof. The examples may be performed by general purpose circuitry. Examples of general purpose circuitry include digital signal processors (DSP), central processing units (CPU), co-processor units, field programmable gate arrays (FPGA) and other programmable hardware. Alternatively or additionally, the examples may be performed by specialized circuitry, such as application specific integrated circuits (ASIC). The general purpose circuitry and/or the specialized circuitry may, for example, be associated with or comprised in an electronic apparatus such as a vehicle control unit (VCU) or other suitable control unit.

The electronic apparatus may comprise arrangements, circuitry, and/or logic according to any of the examples described herein. Alternatively or additionally, the electronic apparatus may be configured to perform method steps according to any of the examples described herein.

According to some examples, a computer program product comprises a non-transitory computer readable medium such as, for example, a universal serial bus (USB) memory, a plug-in card, an embedded drive, or a read only memory (ROM). FIG. 10 illustrates a computer program product 1000 exemplified as a non-transitory computer-readable medium in the form of a compact disc (CD) ROM 1050. The computer-readable medium has stored thereon program code 1040 comprising instructions. The program code is loadable into processing circuitry (PROC; e.g., a data processing unit) 1020, which may, for example, be comprised in a control unit 1010 (e.g., a VCU). When loaded into the processing circuitry, the program code may be stored in a memory (MEM) 1030 associated with, or comprised in, the processing circuitry. According to some examples, the program code may, when loaded into, and run by, the processing circuitry, cause execution of method steps according to, for example, any of the methods described herein.

FIG. 11 schematically illustrates, in terms of a number of functional units, the components of a control unit 1100 according to some examples. Processing circuitry 1110 is provided using any combination of one or more of a suitable central processing unit CPU, multiprocessor, microcontroller, digital signal processor DSP, etc., capable of executing software instructions stored in a computer program product, e.g. in the form of a storage medium 1130. The processing circuitry 1110 may further be provided as at least one application specific integrated circuit ASIC, or field programmable gate array FPGA.

Particularly, the processing circuitry 1110 is configured to cause the control unit 1100 to perform a set of operations, or steps, such as any of the methods discussed in connection to FIG. 1.

For example, the storage medium 1130 may store the set of operations, and the processing circuitry 1110 may be configured to retrieve the set of operations from the storage medium 1130 to cause the control unit 1100 to perform the set of operations. The set of operations may be provided as a set of executable instructions. Thus, the processing circuitry 1110 is thereby arranged to execute methods as herein disclosed. In particular, there is disclosed a control unit 1100 comprising processing circuitry 1110, an interface 1120 coupled to the processing circuitry 1110, and a memory 1130 coupled to the processing circuitry 1110, wherein the memory comprises machine readable computer program instructions that, when executed by the processing circuitry, causes the control unit to perform the methods discussed herein.

The storage medium 1130 may also comprise persistent storage, which, for example, can be any single one or combination of magnetic memory, optical memory, solid state memory or even remotely mounted memory.

The control unit 1100 may further comprise an interface 1120 for communications with at least one external device. As such, the interface 1120 may comprise one or more transmitters and receivers, comprising analogue and digital components and a suitable number of ports for wireline or wireless communication.

The processing circuitry 1110 controls the general operation of the control unit 1100, e.g., by sending data and control signals to the interface 1120 and the storage medium 1130, by receiving data and reports from the interface 1120, and by retrieving data and instructions from the storage medium 1130. Other components, as well as the related functionality, of the control node are omitted in order not to obscure the concepts presented herein.

### A FIRST NON-EXHAUSTIVE LIST OF EXAMPLES

Example 1: A computer system for detection of ground surface height variation in a vicinity of a vehicle, the computer system comprising processing circuitry configured to: acquire measured backscatter from a radar transceiver mounted on the vehicle and directed at the ground surface; compare the measured backscatter to expected ground surface backscatter according to a current vehicle motion; and detect a ground surface height variation responsive to a difference between the expected ground surface backscatter and the measured backscatter satisfying a detection criterion.

Example 2: The computer system of Example 1, wherein the detected ground surface height variation comprises an edge of the ground surface.

Example 3: The computer system of any of Examples 1-2, wherein the processing circuitry is further configured to determine the expected ground surface backscatter according to the current vehicle motion.

Example 4: The computer system of any of Examples 1-3, wherein the current vehicle motion comprises vehicle velocity over the ground surface in a direction corresponding to a facing direction or boresight direction of the radar transceiver.

Example 5: The computer system of any of Examples 1-4, wherein the measured backscatter comprises signal power distribution in a space spanned by radial velocity of the radar transceiver relative to the ground surface and by radial distance of the radar transceiver from the ground surface.

Example 6: The computer system Example 5, wherein the expected ground surface backscatter indicates an expected shape in the space spanned by radial velocity of the radar transceiver relative to the ground surface and by radial distance of the radar transceiver from the ground surface.

Example 7: The computer system of Example 6, wherein the processing circuitry is configured to compare the measured backscatter to the expected ground surface backscatter by applying a spatial filter to the measured backscatter, wherein the spatial filter corresponds to the expected shape in the space spanned by radial velocity of the radar transceiver relative to the ground surface and by radial distance of the radar transceiver from the ground surface.

Example 8: The computer system of Example 7, wherein the detection criterion comprises that a signal power profile of the measured backscatter as filtered has a more prominent power decrease with radial distance than a corresponding signal power profile of the expected ground surface backscatter.

Example 9: The computer system of any of Examples 1-8, wherein the difference between the expected ground surface backscatter and the measured backscatter indicates one or more of: a distance from the radar transceiver to the ground surface height variation, and an angular orientation relative the radar transceiver of the ground surface height variation.

Example 10: The computer system of any of Examples 1-9, wherein the processing circuitry is further configured to cause a safety enhancing action responsive to detection of the ground surface height variation.

Example 11: A vehicle comprising the computer system of any of Examples 1-8.

Example 12: The vehicle of Example 11, further comprising one or more radar transceivers mounted on the vehicle and directed at the ground surface, and configured to provide the measured backscatter.

Example 13: A computer-implemented method for detection of ground surface height variation in a vicinity of a vehicle, the method comprising: acquiring, by processing circuitry of a computer system, measured backscatter from a radar transceiver mounted on the vehicle and directed at the ground surface; comparing, by the processing circuitry, the measured backscatter to expected ground surface backscatter according to a current vehicle motion; and detecting, by the processing circuitry, a ground surface height variation responsive to a difference between the expected ground surface backscatter and the measured backscatter satisfying a detection criterion.

Example 14: The method of Example 13, wherein the detected ground surface height variation comprises an edge of the ground surface.

Example 15: The method of any of Examples 13-14, further comprising determining, by the processing circuitry, the expected ground surface backscatter according to the current vehicle motion.

Example 16: The method of any of Examples 13-15, wherein the current vehicle motion comprises vehicle velocity over the ground surface in a direction corresponding to a facing direction or boresight direction of the radar transceiver.

Example 17: The method of any of Examples 13-16, wherein the measured backscatter comprises signal power distribution in a space spanned by radial velocity of the radar transceiver relative to the ground surface and by radial distance of the radar transceiver from the ground surface.

Example 18: The method Example 17, wherein the expected ground surface backscatter indicates an expected shape in the space spanned by radial velocity of the radar transceiver relative to the ground surface and by radial distance of the radar transceiver from the ground surface.

Example 19: The method of Example 18, wherein comparing the measured backscatter to the expected ground surface backscatter comprises applying, by the processing circuitry, a spatial filter to the measured backscatter, wherein the spatial filter corresponds to the expected shape in the space spanned by radial velocity of the radar transceiver relative to the ground surface and by radial distance of the radar transceiver from the ground surface.

Example 20: The method of Example 19, wherein the detection criterion comprises that a signal power profile of the measured backscatter as filtered has a more prominent power decrease with radial distance than a corresponding signal power profile of the expected ground surface backscatter.

Example 21: The method of any of Examples 13-20, wherein the difference between the expected ground surface backscatter and the measured backscatter indicates one or more of: a distance from the radar transceiver to the ground surface height variation, and an angular orientation relative the radar transceiver of the ground surface height variation.

Example 22: The method of any of Examples 13-21, further comprising causing, by the processing circuitry, a safety enhancing action responsive to detection of the ground surface height variation.

Example 23: A computer program product comprising program code for performing, when executed by the processing circuitry, the method of any of Examples 13-22.

Example 24: A non-transitory computer-readable storage medium comprising instructions, which when executed by the processing circuitry, cause the processing circuitry to perform the method of any of Examples 13-22.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A computer system for detection of ground surface height variation in a vicinity of a vehicle, the computer system comprising processing circuitry configured to:
acquire measured backscatter from a radar transceiver mounted on the vehicle and directed at the ground surface;
compare the measured backscatter to expected ground surface backscatter according to a current vehicle motion; and
detect a ground surface height variation responsive to a difference between the expected ground surface backscatter and the measured backscatter satisfying a detection criterion.

2. A vehicle comprising the computer system of claim 1.

3. The vehicle of claim 2, further comprising one or more radar transceivers mounted on the vehicle and directed at the ground surface, and configured to provide the measured backscatter.

4. A computer-implemented method for detection of ground surface height variation in a vicinity of a vehicle, the method comprising:
acquiring, by processing circuitry of a computer system, measured backscatter from a radar transceiver mounted on the vehicle and directed at the ground surface;
comparing, by the processing circuitry, the measured backscatter to expected ground surface backscatter according to a current vehicle motion; and
detecting, by the processing circuitry, a ground surface height variation responsive to a difference between the expected ground surface backscatter and the measured backscatter satisfying a detection criterion.

5. The method of claim 4, wherein the detected ground surface height variation comprises an edge of the ground surface.

6. The method of claim 4, further comprising determining, by the processing circuitry, the expected ground surface backscatter according to the current vehicle motion.

7. The method of claim 4, wherein the current vehicle motion comprises vehicle velocity over the ground surface in a direction corresponding to a facing direction or boresight direction of the radar transceiver.

8. The method of claim 4, wherein the measured backscatter comprises signal power distribution in a space spanned by radial velocity of the radar transceiver relative to the ground surface and by radial distance of the radar transceiver from the ground surface.

9. The method claim 8, wherein the expected ground surface backscatter indicates an expected shape in the space spanned by radial velocity of the radar transceiver relative to the ground surface and by radial distance of the radar transceiver from the ground surface.

10. The method of claim 9, wherein comparing the measured backscatter to the expected ground surface backscatter comprises applying, by the processing circuitry, a spatial filter to the measured backscatter, wherein the spatial filter corresponds to the expected shape in the space spanned by radial velocity of the radar transceiver relative to the ground surface and by radial distance of the radar transceiver from the ground surface.

11. The method of claim 10, wherein the detection criterion comprises that a signal power profile of the measured backscatter as filtered has a more prominent power decrease with radial distance than a corresponding signal power profile of the expected ground surface backscatter.

12. The method of claim 4, wherein the difference between the expected ground surface backscatter and the measured backscatter indicates one or more of: a distance from the radar transceiver to the ground surface height variation, and an angular orientation relative the radar transceiver of the ground surface height variation.

13. The method of claim 4, further comprising causing, by the processing circuitry, a safety enhancing action responsive to detection of the ground surface height variation.

14. A computer program product comprising program code for performing, when executed by the processing circuitry, the method of claim 4.

15. A non-transitory computer-readable storage medium comprising instructions, which when executed by the processing circuitry, cause the processing circuitry to perform the method of claim 4.
